(19) United States
(12) Patent Application Publication
(10) Pub. No.: US 2011/0236216 A1
(43) Pub. Date: Sep. 29, 2011

(54) WIND TURBINE MOUNTING SYSTEM FOR NON-TURBINE PURPOSE BUILT STRUCTURES

(76) Inventor: Jeffrey M. Konopacki, Winneconne, WI (US)

(21) Appl. No.: 12/748,480

(22) Filed: Mar. 29, 2010

(51) Int. Cl. F03D 11/04; B23P 11/00

(52) U.S. Cl. 416/244 R; 29/428

(57) ABSTRACT

A system and method of mounting a wind turbine to the top of a structure which is not designed to support the possible moment exerted in the structure by the wind turbine. The mount may be connected to a base of the structure by one or more tension members which may exert a downward force on a turbine mount, where the force is selected to correspond to a moment calculated to be possibly exerted on the structure by wind acting on the wind turbine.

### BRIEF DESCRIPTION OF THE INVENTION

The invention described herein provides a methodology for mounting a wind turbine device to non-turbine purpose built structures (such as farm silos) to eliminate the cost of a purpose built wind turbine tower and the interference of typical guy wires. Non-turbine purpose built structures are classified into two categories. Structures that are strong only in compression (e.g. concrete) and structures that are relatively strong in both compression and tension (e.g. steel). The invention defines a continuous compression solution for compression only structures and a distributed mounting structure solution for structures capable of both compression and tension.

The use of non-turbine purpose built structures is desirable due to availability and cost; however, by definition these structures were not designed to handle the forces implied by a wind turbine which can be quite substantial. The invention provides the appropriate mechanisms to securely mount a wind turbine device to non-turbine purpose built structures such that the forces generated by the wind turbine are properly distributed within the capabilities of the existing structure.

### BRIEF DESCRIPTION OF THE DRAWINGS

The accompanying drawing figures, which are incorporated in and constitute a part of the description, illustrate several aspects of the invention and together with the description, serve to explain the principles of the invention. A brief description of the figures is as follows:

FIG. 1 is a perspective view of wind turbines mounted to the top of non-turbine purpose built structures, for example, different types of silos, according to the present disclosure.

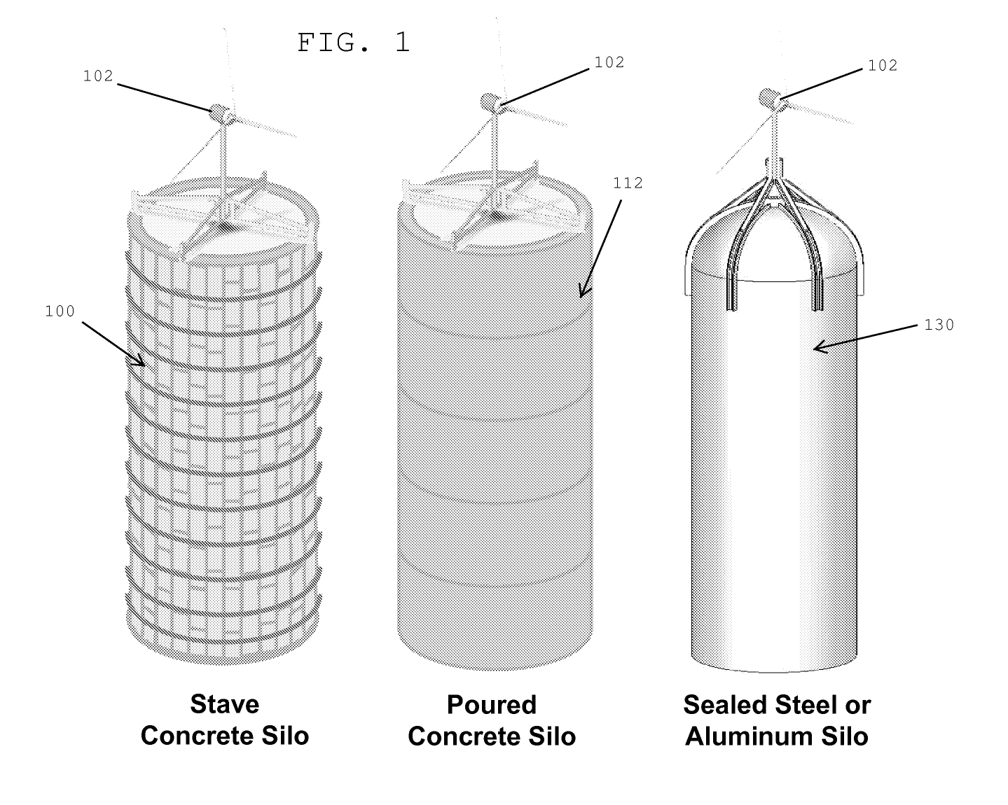

FIG. 2 is a schematic diagram of a prior art self supporting tubular structure with a mass foundation with a wind turbine mounted to the top.

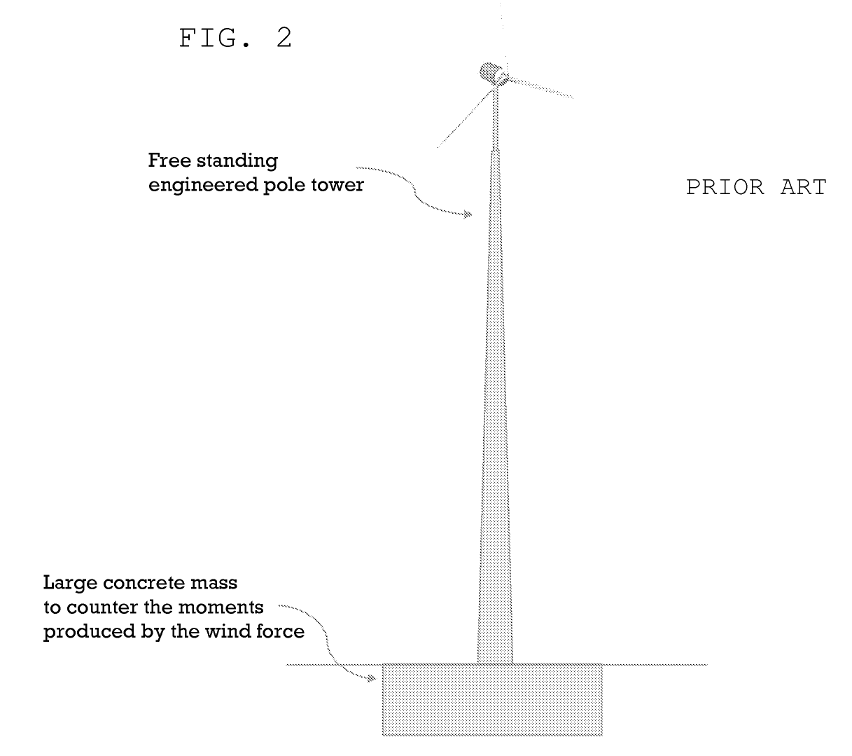

FIG. 3 is a schematic diagram of a prior art non-self supporting tubular structure using mass foundations and requiring guy wires to counter wind loads with a wind turbine mounted to the top.

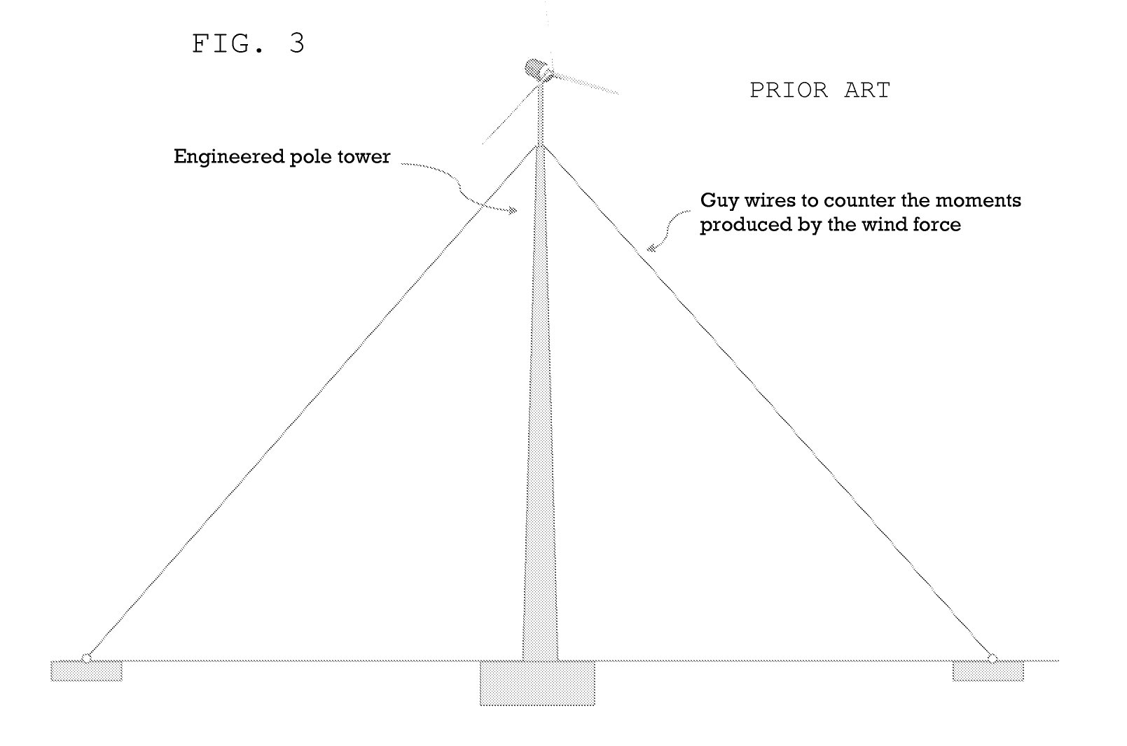

FIG. 4 is a schematic diagram of a prior art self supporting open truss structure with a mass foundation with a wind turbine mounted to the top.

FIG. 5 is a schematic diagram of a prior art non-self supporting open truss structure using mass foundations and requiring guy wires to counter wind loads with a wind turbine mounted to the top.

FIG. 6 is a schematic diagram of concrete non-turbine purpose built silos with a wind turbine mounted to the top of each silo using a mount according to the present disclosure, with the tension members omitted to illustrate the loads placed on the silo by wind loads.

FIG. 7 is a schematic diagram of concrete silos and turbines of FIG. 6, with tension members added to counteract tensile forces in the silos created by wind loads.

FIG. 8 is a schematic diagram of a prior art steel or aluminum non-turbine built silo with a wind turbine mounted to the top.

FIG. 9 is a schematic diagram of a steel or aluminum non-turbine built silo with a wind turbine mounted to the top with a mount according to the present invention.

FIG. 10 is a overhead schematic view comparing the footprint of a guy wire supported structure with a wind turbine mounted on top with a silo with a turbine mounted to the top with a mount according to the present disclosure.

### DEFINITIONS, TERMS, ELEMENTS

Wind turbine—a device used for converting wind energy into electrical energy

Purpose built wind turbine tower—a structure which is erected solely for the purposes of mounting a wind turbine

Non-turbine purpose built structures—a structure suitable for mounting a wind turbine which has been previously built (or will be built) for an application or use other than the mounting of a wind turbine. Examples are silos, stacks, water towers, ski lift towers, etc. . . .

Guy wires—series of cables used to connect the top of a tower to the ground typically at a 45 degree angle

Continuous compression—a mounting methodology defined within this invention to place a structure into sufficient compression such that the forces generated from a wind turbine mounted on its top will never put any part of the original structure into tension.

Distributed mounting structure—a mounting methodology defined within this invention to strengthen structures sufficiently such that the forces generated from a wind turbine mounted on its top will never push any part of the original structure beyond its capabilities.

### BACKGROUND OF THE INVENTION (PRIOR ART)

Typically, a purpose built turbine tower (engineered pole or truss tower) is used to elevate a wind turbine to the appropriate height. There are two general types of these structures: free standing and guy wire supported. Free standing structures necessitate a large mass (usually concrete) to counter the moment created by the wind force. Guy wire structures use much smaller tube or truss structures with a similar, but smaller mass in addition to tensioned guy wires anchored to the earth to counter the wind generated moments.

The figures herein depict the most common types of wind mill towers/structures selected from among the myriad possible existing structures that might be used for turbine mounting according to the present disclosure. The following description is exemplary only and is not intended to limit in any way the type and nature of existing structures that may be used to mount a turbine according to the present disclosure.

### APPLICABLE PATENT PRIOR ART

| | | |
|---|---|---|
| U.S. Pat. No. 4,524,528 | Wind powered | Jun. 25, 1985 |
| | grain drying apparatus | |
| U.S. Pat. No. 5,419,683 | Wind turbine | May 30, 1995 |
| U.S. Pat. No. 6,157,088 | Wind energy system | Dec. 5, 2000 |

### DETAILED DESCRIPTION OF THE INVENTION

Reference will now be made in detail to exemplary aspects of the present invention which are illustrated in the accompanying drawings. Wherever possible, the same reference numbers will be used throughout the drawings to refer to the same or like parts.

Mounting a wind turbine to a non-turbine purpose built structure will likely be problematic due to the large moments created by the wind force on the wind turbine. Most existing structures that might be desirable for mounting a wind turbine (silos, stacks, water towers, ski lift towers, etc. . . . ) were not designed for this purpose and did not include such structural limitations in their initial design parameters. The moments or loads created by the wind turbine and the force of the wind acting on the turbine may cause tension in one part of the structure and compression on the opposite side. The locations of the tension and compression loads will change with the prevailing wind direction. The present disclosure describes but is not limited to two preferred mechanisms for mounting the wind turbine such that the structure is properly strengthened to handle the additional moments produced by the wind turbine. To explain the invention, non-turbine purpose built structures have been classified into two categories:

1) Structures which are very strong in compression but not tension such as but not limited to silos made from poured concrete, block, brick, or stave.

2) Structures which are relatively strong in both compression and tension such as but not limited to silos made from steel, aluminum, or wood.

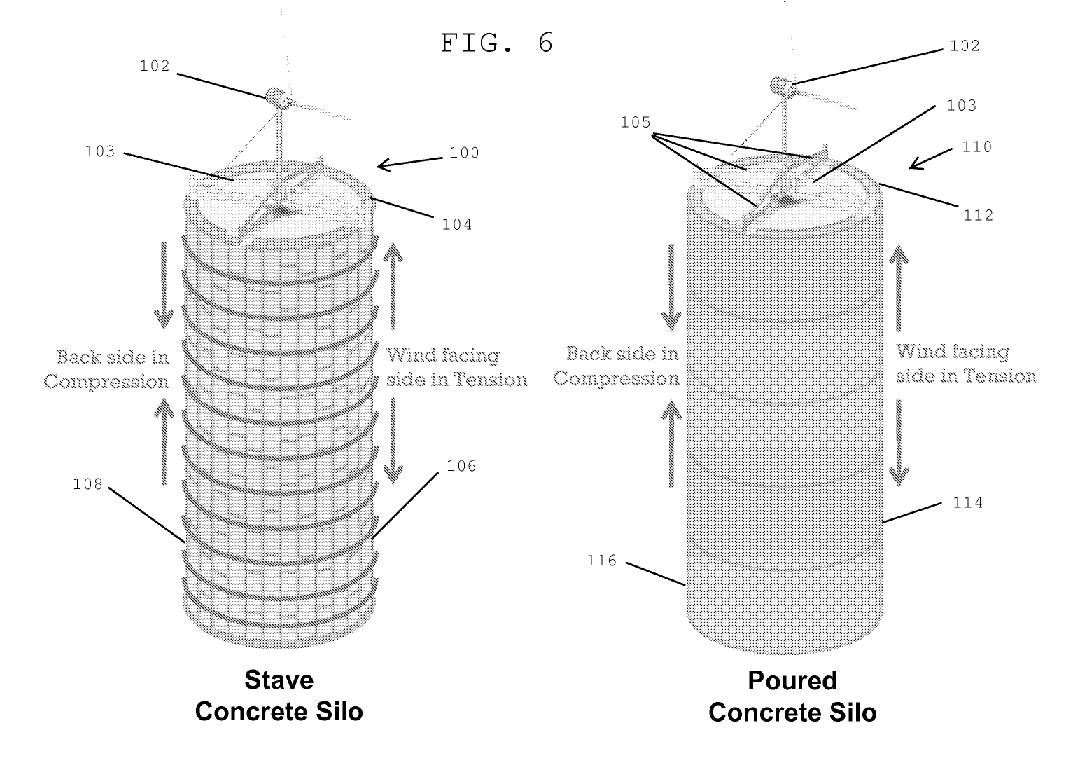

FIG. 6 shows the forces created on structures such as a stave concrete silo 100 when a wind turbine 102 and a mount 103 according to the present disclosure is mounted to a top 104 of silo 100. Mount 103 may include a plurality of legs or strength members 105 to spread the weight of the turbine and any moment generated by wind acting on the turbine to top of the wall of the silo. FIG. 6 also shows the similar forces created on a structure such as a poured concrete silo 110 when a wind turbine 102 and a mount 103 are mounted to a top 112 of silo 110

A first side 106 of silo 100 which faces into the wind is put into tension while an opposite side 108 of silo 100 may be put into compression. A first side 114 of silo 110 which faces into the wind may be similarly put into tension while an opposite side 116 may be put into compression. For concrete, block, brick, or stave structures which are strong in compression (and not tension), the tensile forces will likely destroy the silo over time.

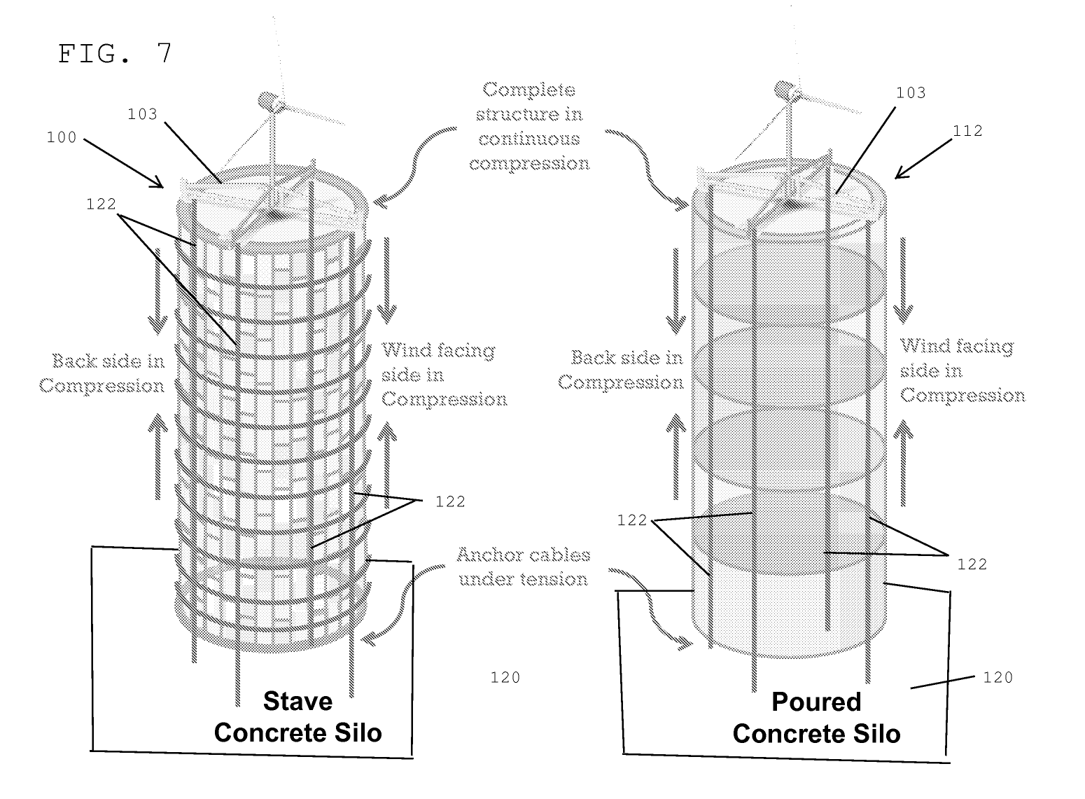

For structures strong and/or stable in compression, the present disclosure provides continuous compression on the structure such that no portion of the structure ever goes into tension. FIG. 7 shows one of many embodiments according the present disclosure that preloads compression-resistant and tension-intolerant structures so that the structures may be kept in continuous compression. Mount 103 on top of silo 100 may be connected to a base 120 of the silo by a plurality of anchor cables acting as tension members 122. While mount 103 is shown as a four legged mount that engages top 104 at four points generally evenly spaced apart about the circumference, it is anticipated that more or fewer legs may be used. Alternatively, mount 103 may form a generally unbroken cover over top 104 of silo 100 and spread the load evenly about the entire top edge of the walls of the silo.

Once the mount has been placed on the top of the silo and secured to the base of the silo, the tension members or anchor cables 122 may be loaded in tension so that the cables urge the mount downward onto top 104 of silo 100. The tension in anchor cables 122 is preferably set to a sufficient tension so that any wind loads that might otherwise place one side of the silo into tension are counteracted. For example, the tension in cables 122 may be selected to be greater than the maximum force induced by the wind turbine such that the structure is kept in continuous compression, regardless of wind speed or direction. This will ensure that structures strong in compression will never be stressed in a manner which may deteriorate or destroy the structure.

In FIG. 7, silo 110 may also be similarly configured with mount 103 anchored to base 120 by anchor cables 122 that are tensioned sufficiently to prevent any portion of the silo from being placed under tension by wind loads acting on the turbine or the mount.

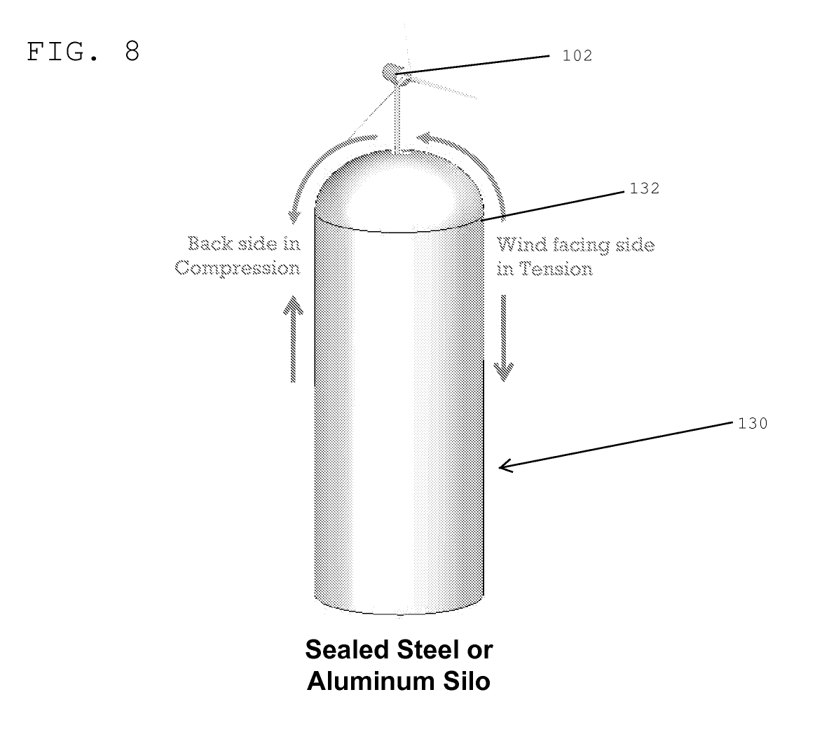

FIG. 8 shows the forces created on an exemplary structure such as steel or aluminum silo 130 when a wind turbine 102 is mounted to a top 132 of the silo. Steel or aluminum structures are relatively strong in both compression and tension; however, they may not be capable of handling the additional forces induced by a wind turbine. Particularly for a structure such as a silo 130 that was designed to contain bulk items, the upper portions of the structure may not have been designed to handle the magnitude and direction of loads that a turbine may exert on the silo.

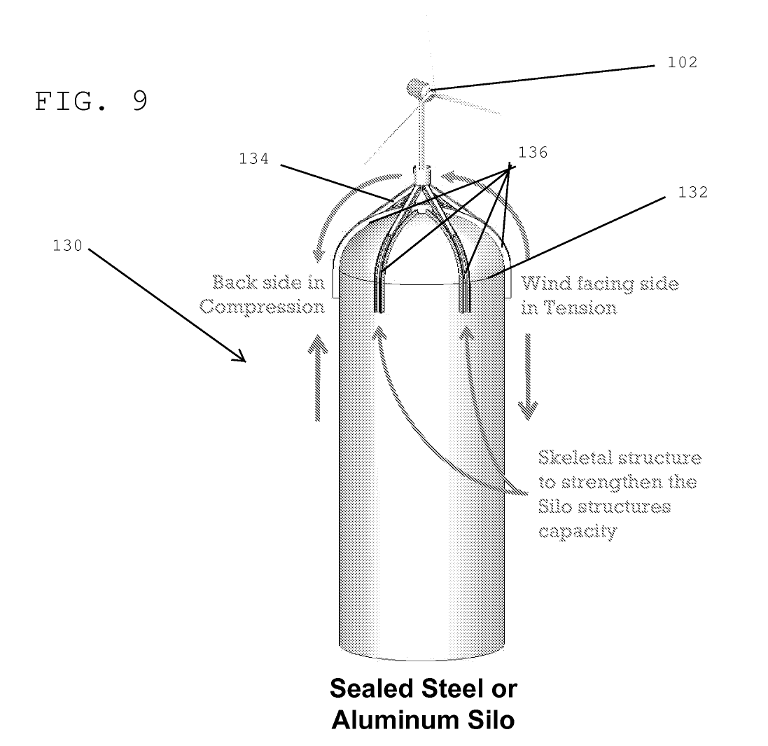

For structures relatively strong in both compression and tension, the present disclosure provides a distributed mounting structure within or on the structure to ensure the forces induced by the wind turbine never exceed the capacity of any portion of the structure. FIG. 9 shows an embodiment of a mount 134 for mounting a turbine 102 to the top 132 of a non-turbine purpose built structures which may distribute the loads from the turbine and the wind loads to ensure the forces induced by the wind turbine do not exceed the capacity of the original structure. There may be a plurality of strength members 136 that fit over the existing top structure of silo 130 and distribute the increased loads due to the turbine across the top to the sides of the structure. Additional strength members 136 (if required) within the silo may be part of the distributed mounting structure 134 to help ensure that the structure 130 is capable of handling the additional moments and other loads created by the wind turbine. As the structure itself is capable of carrying both tensile and compression loads, it may not be necessary to provide pre tensioned anchor cables such as cables 122. However, depending on the strength of the existing structure and the weight and potential wind loads of turbine 102, it may be desirable to have strength members 136 that extend to the base 120 to provide additional support to the walls of silo 130.

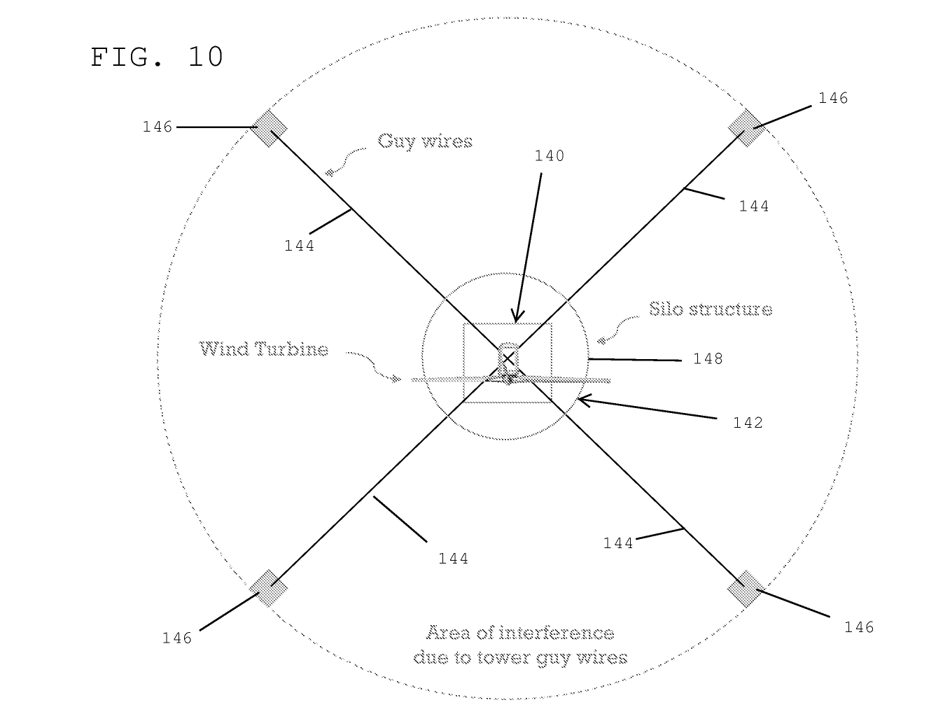

As compared with purpose built wind turbine towers using guy wires, the use of non-turbine purpose built structures may reduce the footprint size. FIG. 10 shows a top view comparing a guy wire tower 140 mount to a silo 142 mount. The footprint size (interference area) of the guy wire mount structure is significantly larger that that of the silo structure, due to a dispersed position of a plurality of guy wires 144 required to support the tower 140 and their anchor points 146, as compared to the footprint of an outer wall 148 of silo 142. Depending on the location of the wind turbine site, the footprint size may be very important to the owner/operator of the wind turbine.

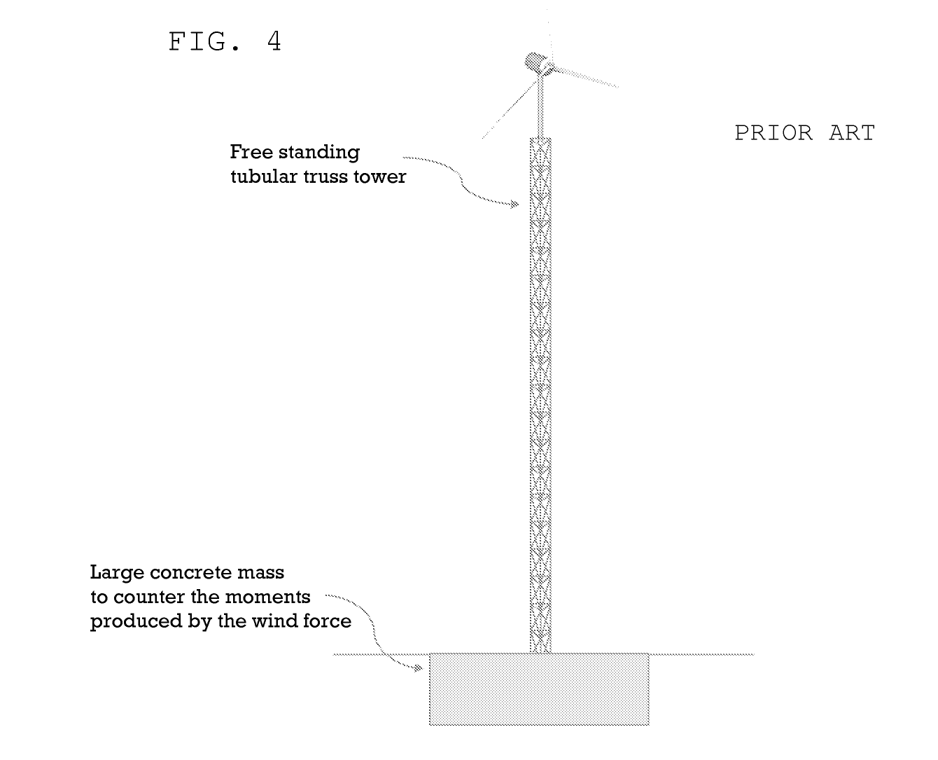

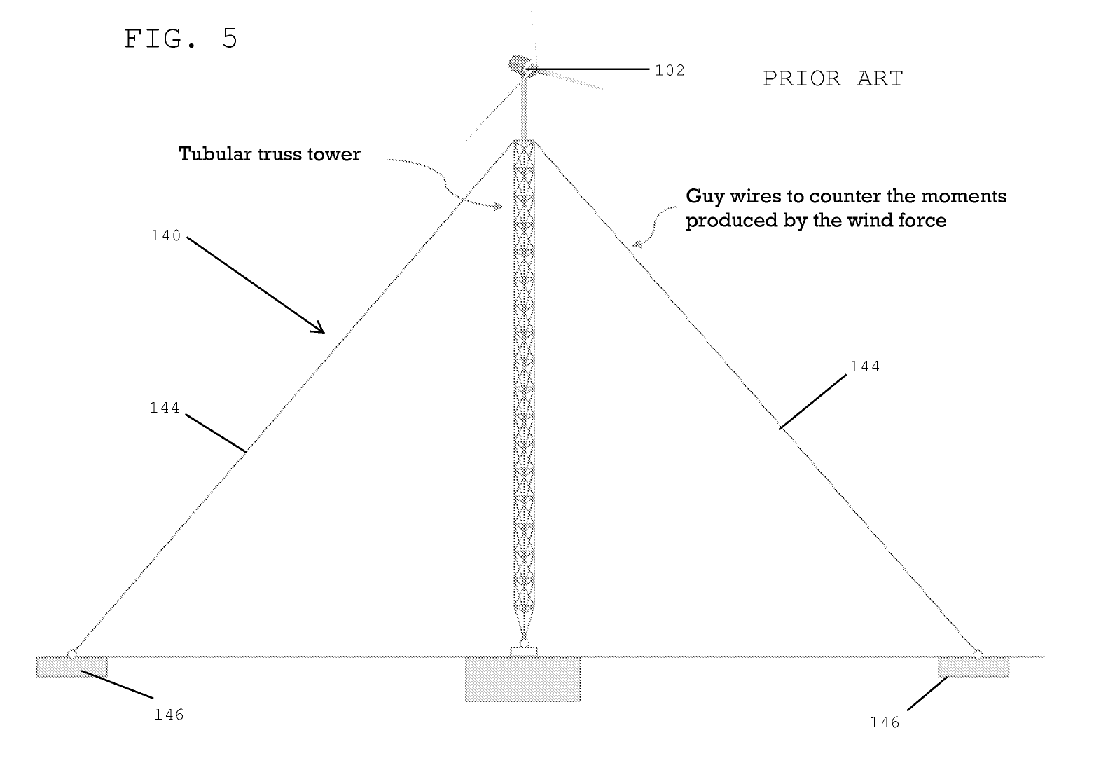

FIG. 5 illustrates a side view of tower 140. FIG. 4 illustrates

### Alternate Embodiments

1. Non-turbine purpose built structures suitable for mounting a wind turbine that have not been mentioned specifically within this disclosure
2. Alternative methods or tensile structures for applying continuous compression to a concrete, block, brick, or other type of construction strong in compression.
3. Alternative methods of applying a distributive mounting structure to a steel, aluminum, or other type of construction relatively strong in both tension and compression.

### ADVANTAGES OF THE INVENTION COMPARED TO PRIOR ART

The major advantage of using non-turbine purpose built structures is cost. Additional advantages are as follows:
Structures are in place today (or planned) thereby reducing time and costs of installation.
Structures usually have high power electrical infrastructure already in place, particularly farms which already have a large connection to the power grid to provide electrical power to the various electric motors used in typical farm operations.
Structures do not require external guy wires thereby reducing the footprint size.

While the invention has been described with reference to preferred embodiments, it is to be understood that the invention is not intended to be limited to the specific embodiments set forth above. Thus, it is recognized that those skilled in the art will appreciate that certain substitutions, alterations, modifications, and omissions may be made without departing from the spirit or intent of the invention. Accordingly, the foregoing description is meant to be exemplary only, the invention is to be taken as including all reasonable equivalents to the subject matter of the invention, and should not limit the scope of the invention set forth in the following claims.

What is claimed is:

1. A method of mounting a wind turbine to an existing structure comprising:
determining the moment exerted by the wind turbine when the turbine is mounted to the structure;
attaching a turbine mount to a top of the structure to support the turbine;
applying a downward force to the turbine mount by tension members extending from the turbine mount to a base of the structure, the amount of force applied proportional to the moment exerted by the wind turbine when mounted to the structure;
attaching the wind turbine to the turbine mount.

2. The method of claim 1, wherein the structure is a self-supporting structure that is not configured to resist the moment of a turbine mounted to the top of the structure.

3. The method of claim 1, wherein the structure is a bulk storage silo.

4. The method of claim 3, wherein the silo is constructed primarily of concrete.

5. The method of claim 4, further comprising mounting of a plurality of tension members between the turbine mount and the base within the silo, with the tension members generally spaced evenly about an interior of the silo.

6. A system for mounting a wind turbine to an existing non-turbine structure, the structure having a top and being positioned atop a base, the system comprising:
a turbine mount configured to be placed on a top of the structure;
a plurality of tension members sized to extend from the mount to the base;
the mount further configured to connect to the tension members and permit the tension members to apply a downward force on the mount.

7. The system of claim 6, wherein the downward force applied by the tension members on the mount is selected to correspond to a moment calculated to be exerted on the structure by a wind turbine mounted to the mount.

8. The system of claim 6, wherein the structure is a bulk storage silo.

9. The system of claim 7, wherein the tension members extend between the mount and the base within an interior of the silo.

10. The system of claim 7, wherein the silo is constructed primarily of concrete.

11. A mounting system for mounting a wind turbine to the top of a non-turbine bulk storage silo, the mount comprising:
means for attaching a turbine to the mount;
a plurality of strength members that extend to engage a top of the silo;
at least one tension member extending from each strength member that is configured to connect to the mount to a base of the silo.
